(19) United States
(12) Patent Application Publication
(10) Pub. No.: US 2026/0187370 A1
(43) Pub. Date: Jul. 2, 2026

(54) SYSTEM AND METHOD FOR EXECUTING CLASSIFICATION TECHNIQUES USING LLMS

(71) Applicant: INTUIT INC., Mountain View, CA (US)

(72) Inventors: Shai ARDAZI, Tel Aviv (IL); Guy LEV, Tel Aviv (IL); Lior Vassertail AZROEL, Tel Aviv (IL); Linoy COHEN, Tel Aviv (IL)

(73) Assignee: INTUIT INC., Mountain View, CA (US)

(21) Appl. No.: 19/005,263

(22) Filed: Dec. 30, 2024

(51) Int. Cl. G06F 40/284; G06F 16/353

(52) U.S. Cl. CPC G06F 40/284; G06F 16/353

(57) ABSTRACT

A system and method are provided for executing classification techniques using large language models (LLMs).

### BACKGROUND OF THE DISCLOSURE

Textual classification is a prominent and pervasive challenge in natural language processing, and such a challenge can span across a wide range of industries. For example, textual classification and its challenges are consistently being addressed in domains such as sentiment analysis, voice and tone analysis, and other areas that utilize pre-defined classes.

Current classification approaches generally involve either supervised or unsupervised learning techniques. Most unsupervised techniques for solving textual classification problems that utilize large language models (LLMs) generally involve prompt engineering and selecting the output generated by the LLM as the final classification. Approaches to improving such techniques generally are limited as they select the class with the highest score directly from the LLM's output vector. This means that the techniques tend to ignore the relative importance of certain tokens in the output vector, which is undesirable as it can lead to poor accuracy and is prone to intrinsic biases of the model weights.

### BRIEF DESCRIPTION OF THE FIGURES

FIG. 1 is a block diagram of an example system for executing classification techniques using LLMs according to example embodiments of the present disclosure.

FIG. 2 is a flowchart of an example process for executing classification techniques using LLMs according to example embodiments of the present disclosure.

FIG. 3 is server that can be used within the system of FIG. 1 according to an embodiment of the present disclosure.

FIG. 4 is an example computing device that can be used within the system of FIG. 1 according to an embodiment of the present disclosure.

The drawings are not necessarily to scale, or inclusive of all elements of a system, emphasis instead generally being placed upon illustrating the concepts, structures, and techniques sought to be protected herein.

### DESCRIPTION

The following detailed description is merely exemplary in nature and is not intended to limit the claimed invention or the applications of its use.

Embodiments of the present disclosure are directed to a system and method for executing classification techniques using LLMs. The disclosed system and method can execute classification techniques (i.e., can make classification predictions) that are more accurate and significantly more computationally efficient by not requiring additional compute requirements beyond what existing, but suboptimal, techniques utilize. When LLMs generate outputs, they will generally output a token vector that includes a token probability value for a large plurality of tokens (e.g., words or letters forming words). The disclosed system and method can utilize various pre-built groups of words for each class of a classification prompt. After the classification prompt is fed to the LLM, the disclosed system and method can identify and extract the token probabilities from the LLM for each word in the pre-built groups of words. The extracted token probabilities can be analyzed to generate a final classification for the original prompt.

In this manner, the disclosed system and method can account for the relative importance of the tokens within the output tokens vector generated by the LLM. Moreover, the disclosed system and method is a more robust and accurate way of determining a class given input text with no additional compute requirements, as the tokens vector is already generated and provided by the LLM with an output.

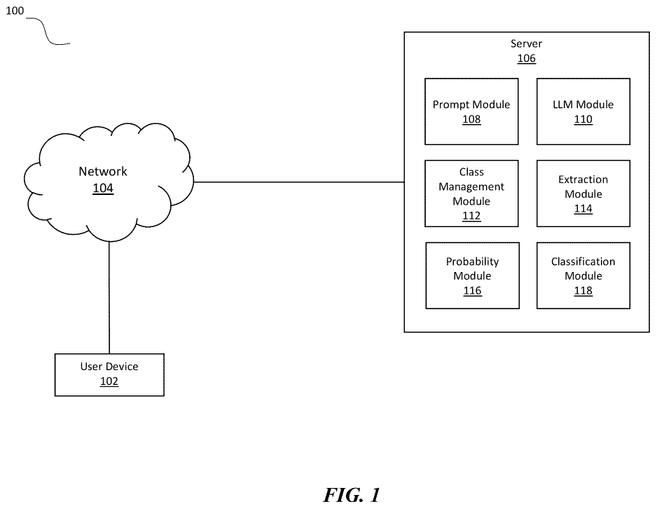

FIG. 1 is a block diagram of an example system 100 for executing classification techniques using LLMs according to example embodiments of the present disclosure. The system 100 can include one or more user devices 102 (generally referred to herein as a “user device 102” or collectively referred to herein as “user devices 102”) that can access a server 106 via a network 104 to facilitate communication and engage with a classification service or other question-answer-type service that can perform textual classifications contained therein. In some embodiments, the classification service can be a chatbot or other service with which the user can interact. In some embodiments, the classification service can be an external, customer-facing service in which customers of a platform (e.g., an accounting or other financial management platform) can provide classification-based requests and prompts. In addition, the classification service can operate as an internally based service in which engineers, developers, and other employees of an accounting or other financial management platform can provide classification-based requests and prompts. In some embodiments, the system 100 can include any number of user devices 102. For example, for a financial or accounting platform or other website that may offer services to users, there may be an extensive userbase with thousands or even millions of users that connect to the system 100 via their user devices 102 allowing them to ask questions via e.g., a chatbot. Likewise, the financial or accounting platform or other website may include an extensive userbase of various employees. The server 106 can provide responses to user questions (i.e., classifications based on an input prompt) utilizing the principles disclosed herein.

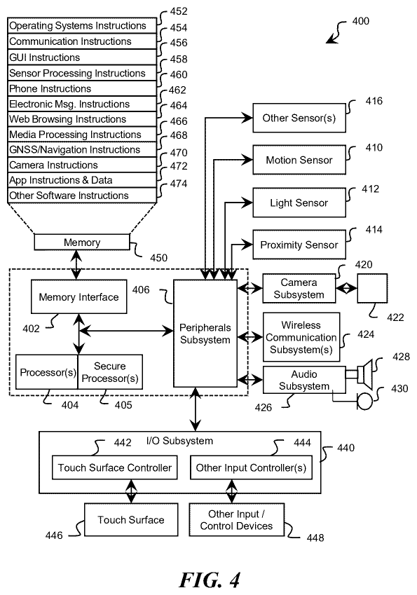

A user device 102 can include one or more computing devices capable of receiving user input, transmitting and/or receiving data via the network 104, and or communicating with the server 106. In some embodiments, a user device 102 can be a conventional computer system, such as a desktop or laptop computer. Alternatively, a user device 102 can be a device having computer functionality, such as a personal digital assistant (PDA), a mobile telephone, a smartphone, or other suitable device. In some embodiments, a user device 102 can be the same as or similar to the computing device 400 described below with respect to FIG. 4.

The network 104 can include one or more wide areas networks (WANs), metropolitan area networks (MANs), local area networks (LANs), personal area networks (PANs), or any combination of these networks. The network 104 can include a combination of one or more types of networks, such as Internet, intranet, Ethernet, twisted-pair, coaxial cable, fiber optic, cellular, satellite, IEEE 801.11, terrestrial, and/or other types of wired or wireless networks. The network 104 can also use standard communication technologies and/or protocols.

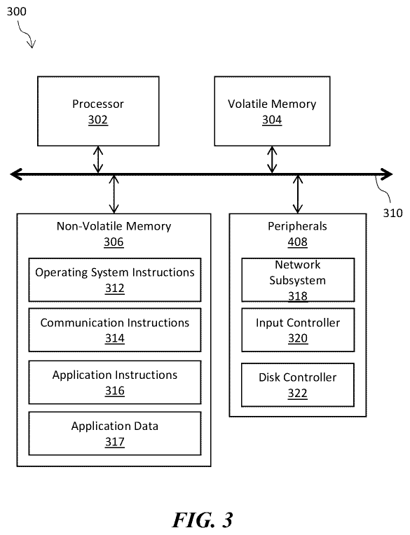

The server 106 may include any combination of one or more of web servers, mainframe computers, general-purpose computers, personal computers, or other types of computing devices. The server 106 may represent distributed servers that are remotely located and communicate over a communications network, or over a dedicated network such as a local area network (LAN). The server 106 may also include one or more back-end servers for carrying out one or more aspects of the present disclosure. In some embodiments, the server 106 may be the same as or similar to server 300 described below with respect to FIG. 3.

As shown in FIG. 1, the server 106 can include a prompt module 108, an LLM module 110, a class management module 112, an extraction module 114, a probability module 116, and a classification module 118.

In some embodiments, the prompt module 108 is configured to enable a user to, via user device 102, interact with a service that performs classification tasks. In particular, the prompt module 108 can receive a classification prompt from a user that has been entered and submitted via user device 102. A first example of a classification prompt can be: “Read the following text which was posted on Twitter and determine the gender of the user who posted this tweet.” This will be referred to herein as the “first example prompt.” A second example of a classification prompt can be: “Read the following two articles and determine a rating that defines whether one article is a paraphrase of the other.” This will be referred to herein as the “second example prompt.” It is important to note that such classification prompts are merely exemplary in nature and that a wide variety of classification prompts can be employed to determine classifications. In some embodiments, the prompt module 108 can also be configured to monitor certain online platforms (e.g., social media, articles, entries within a financial platform, etc.) to ingest posts or other pieces of content and information to provide as an input with the classification prompt. For example, the prompt module 108 could obtain posts over a period of time and submit them to the LLM module 110 with the same classification prompt to continuously monitor and classify posts.

In some embodiments, the LLM module 110 can include an LLM, such as GPT-3,-3.5,-4, PaLM-E, Ernie Bot, LLaMa, and others. In some embodiments, the LLM can include various transformed-based models trained on vast corpuses of data that utilize an underlying neural network. The LLM module 110 can receive an input, such as the input generated by the prompt module 108. The LLM module 110 is configured to analyze the input to classify the original user prompt. In addition, when the LLM module 110 generates an output (i.e., predicting a classification for the original prompt), the LLM module 110 also can generate a token probability vector that includes a probability value, such as a log-probability, for each of a plurality of possible groupings of tokens, such as specific words. In some embodiments, the LLM module 110 utilized herein can operate in an unsupervised setting and in a zero-shot manner, with no pre-training or fine-tuning and little to no few-shot settings provided as an input. In some embodiments, the LLM module 110 can be configured to generate example groupings of tokens to include in class groups discussed below in relation to the class management module 112.

In some embodiments, the class management module 112 can store and maintain groups of sets of relevant tokens. In some embodiments, the class management module 112 can store a group for each possible class associated with a classification prompt. Each group can include alternate words that are associated with or relevant to the possible classes available for classification. For example, referring to the first example prompt, a first group (for the “female” classification) can include {female, woman, women, girl, gal, females, girls, 0} and a second group (for the “male” classification) can include {male, man, men, boy, guy, males, boys, 1}. For the second example prompt, a first group can include {low, small, bad, short, no, not, 0} and a second group can include {high, big, strong, top, good, major, yes, sim, 1}. In some embodiments,, the words (i.e., groupings of tokens) can be automatically generated via the LLM module 110. For example, the LLM module 110 can be prompted to generate alternative words for “women” or “man” or any other relevant class based on the classification prompt. In some embodiments, the words within the groups can be manually defined by a user.

In some embodiments, the extraction module 114 is configured to process the token probability vector, which can be generated by the LLM module 110 when a classification output is generated. The extraction module 114 can communicate with the class management module 112 to identify the words that are in each group. The extraction module 114 can also process the token probability vector to extract the identified words and the corresponding token probability values. For example, referring to the first example prompt discussed above, the extraction module 114 can extract the token probability values (e.g., log-probability values) from the token probability vector for each of the sets of tokens in the first group (female, woman, women, girl, gal, females, girls, 0) and the second group (male, man, men, boy, guy, males, boys, 1). Referring to the second example prompt discussed above, the extraction module 114 can extract the token probability values for each of the sets of tokens in the first group (low, small, bad, short, no, not, 0) and the second group (high, big, strong, top, good, major, yes, sim, 1).

In some embodiments, the probability module 116 is configured to receive the token probability values extracted from the token probability vector by the extraction module 114. The probability module 116 can calculate a mean, median, or other similar statistic for each group. For example, referring to the first example prompt discussed above, the probability module 116 can calculate a mean probability value for each of the first group (female, woman, women, girl, gal, females, girls, 0) and the second group (male, man, men, boy, guy, males, boys, 1). For the second example prompt, the probability module 116 can calculate a mean probability value for the first group (low, small, bad, short, no, not, 0) and the second group (high, big, strong, top, good, major, yes, sim, 1).

In some embodiments, the classification module 118 is configured to determine a final classification for the original prompt based on the group that has the highest mean probability value. For example, referring to the first example prompt discussed above, the classification module 118 determines whether the first group or the second group has a higher mean probability. If the first group has a higher mean probability, then the classification for the original prompt would be that the gender of the user who posted the tweet is female. If the second group has a higher mean probability, then the classification for the original prompt would be that the gender of the user who posted the tweet is male. With respect to the second example prompt discussed above, if the first group has a higher mean probability, then the classification for the original prompt would be that one article is not a paraphrase of the other. If the second group has a higher mean probability, then the classification for the original prompt would be that one article is a paraphrase of the other.

The final classification can be transmitted to the relevant user for display.

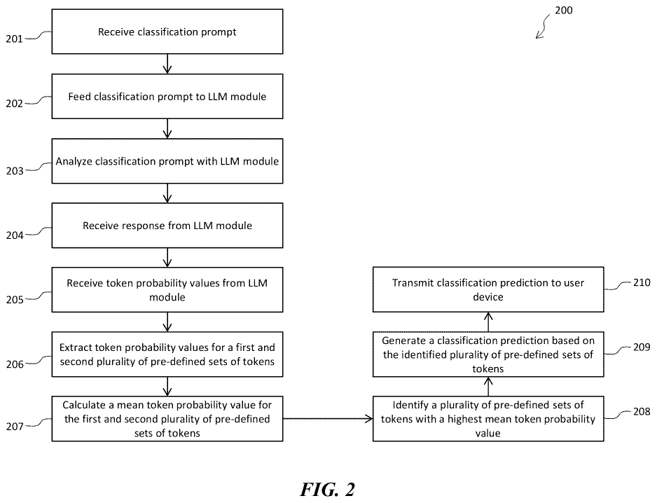

FIG. 2 is a flowchart of an example process 200 for executing classification techniques using LLMs according to example embodiments of the present disclosure. In some embodiments, the process 200 can be performed by the server 106 and its various modules. At block 201, the prompt module 108 receives a classification prompt. In some embodiments, the prompt module 108 can receive the classification prompt from a user device 102. For example, the server 106 can operate a service that a user can interact with to perform classification tasks. An example prompt can be the first example prompt: “Read the following text which was posted on Twitter and determine the gender of the user who posted this tweet.” A second example of a classification prompt can be the second example prompt: “Read the following two articles and determine a rating that defines whether one article is a paraphrase of the other.” In other examples, the prompt module 108 can receive the classification as a result of monitoring various online platforms, such as a social media platform. For example, the prompt module 108 could obtain posts over a period of time and submit those all to the LLM module 110 with the same classification prompt to continuously monitor and classify posts.

At block 202, the prompt module 108 feeds the classification prompt to the LLM module 110. At block 203, the LLM module 110 analyzes the classification prompt and performs the classification task requested in the prompt. In some embodiments, the LLM module 110's analysis can include generating a classification result for the prompt. In addition, the LLM module 110 can generate a token probability vector that includes a probability value (e.g., a log-probability value) for each of a plurality of possible groupings of tokens, such as specific words. In some embodiments, the LLM module 110's analysis can be performed in an unsupervised and zero-shot manner. In some embodiments, the LLM module 110 can generate example groupings of tokens to include in class groups discussed below in relation to block 205. In some embodiments, the prompt module 108 can prompt the LLM module 110 to generate alternate words that are associated with the classes of the original classification prompt. For example, related to the above-discussed example, the LLM module 110 can be prompted to generate alternative words for “women” or “man” or any other relevant class based on the classification prompt. In these embodiments, the LLM module 110 can then generate such alternative words. For example, referring to the first example prompt, the LLM module 110 can generate a first group for the “female” classification that can include {female, woman, women, girl, gal, females, girls, 0} and a second group for the “male” classification that can include {male, man, men, boy, guy, males, boys, 1}. For the second example prompt, a first group can include {low, small, bad, short, no, not, 0} and a second group can include {high, big, strong, top, good, major, yes, sim, 1}. The resulting classes and alternate words for the classes, if they are generated, can be store and maintained by the class management module 112.

At blocks 204 and 205, the extraction module 114 receives the classification response and the token probability values, such as in the form of a token probability vector, from the LLM module 110. At block 206, the extraction module 114 extracts token probability values for a first and second plurality of pre-defined sets of tokens from the token probability vector. In some embodiments, the extraction module 114 can extract probability values for the classes and, if they have been generated, alternate words for the classes that are maintained by the class management module 112. For example, referring to the first example prompt, the extraction module 114 can extract the token probability values (e.g., log-probability values) from the token probability vector for each of the sets of tokens in the first group (female, woman, women, girl, gal, females, girls, 0) and the second group (male, man, men, boy, guy, males, boys, 1). Referring to the second example prompt, the extraction module 114 can extract the token probability values for each of the sets of tokens in the first group (low, small, bad, short, no, not, 0) and the second group (high, big, strong, top, good, major, yes, sim, 1).

At block 207, the probability module 116 calculates a mean token probability value for the first and second plurality of pre-defined sets of tokens. The probability module 116 can receive the token probability values extracted from the token probability vector by the extraction module 114 and calculate a metric for each plurality of predefined sets of tokens. In some embodiments, the metric can include a mean, median, or other similar statistic. For example, referring to the first example prompt, the probability module 116 can calculate a mean probability value for each of the first group (female, woman, women, girl, gal, females, girls, 0) and the second group (male, man, men, boy, guy, males, boys, 1). For the second example prompt, the probability module 116 can calculate a mean probability value for the first group (low, small, bad, short, no, not, 0) and the second group (high, big, strong, top, good, major, yes, sim, 1).

At block 208, the classification module 118 identifies a plurality of pre-defined sets of tokens with a highest metric calculated by the probability module 116. For example, the classification module 118 can determine whether the first group or the second group has a higher mean probability. At block 209, the classification module 118 generates a classification prediction based on the identified plurality of pre-defined sets of tokens. For example, if the first group has a higher mean probability, then the classification for the original prompt would be that the gender of the user who posted the tweet is female. If the second group has a higher mean probability, then the classification for the original prompt would be that the gender of the user who posted the tweet is male. With respect to the second example prompt, if the first group has a higher mean probability, then the classification for the original prompt would be that one article is not a paraphrase of the other. If the second group has a higher mean probability, then the classification for the original prompt would be that one article is a paraphrase of the other. At block 210, the server 106 transmits the classification prediction to the user device 102.

In some embodiments, the principles disclosed herein can also be employed in a less-interactive framework such as a service continually monitoring certain content online to make classifications.

FIG. 3 is a diagram of an example server 300 that can be used within system 100 of FIG. 1 (i.e., as server 106). Server 300 can implement various features and processes as described herein. Server 300 can be implemented on any electronic device that runs software applications derived from complied instructions, including without limitation personal computers, servers, smart phones, media players, electronic tablets, game consoles, email devices, etc. In some implementations, server 300 can include one or more processors 302, volatile memory 304, non-volatile memory 306, and one or more peripherals 308. These components can be interconnected by one or more computer buses 310.

Processor(s) 302 can use any known processor technology, including but not limited to graphics processors and multi-core processors. Suitable processors for the execution of a program of instructions can include, by way of example, both general and special purpose microprocessors, and the sole processor or one of multiple processors or cores, of any kind of computer. Bus 310 can be any known internal or external bus technology, including but not limited to ISA, EISA, PCI, PCI Express, USB, Serial ATA, or FireWire. Volatile memory 304 can include, for example, SDRAM. Processor 302 can receive instructions and data from a read-only memory or a random access memory or both. Essential elements of a computer can include a processor for executing instructions and one or more memories for storing instructions and data.

Non-volatile memory 306 can include by way of example semiconductor memory devices, such as EPROM, EEPROM, and flash memory devices; magnetic disks such as internal hard disks and removable disks; magneto-optical disks; and CD-ROM and DVD-ROM disks. Non-volatile memory 306 can store various computer instructions including operating system instructions 312, communication instructions 314, application instructions 316, and application data 317. Operating system instructions 312 can include instructions for implementing an operating system (e.g., Mac OS®, Windows®, or Linux). The operating system can be multi-user, multiprocessing, multitasking, multithreading, real-time, and the like. Communication instructions 314 can include network communications instructions, for example, software for implementing communication protocols, such as TCP/IP, HTTP, Ethernet, telephony, etc. Application instructions 316 can include instructions for various applications. Application data 317 can include data corresponding to the applications.

Peripherals 308 can be included within server device 300 or operatively coupled to communicate with server device 300. Peripherals 308 can include, for example, network subsystem 318, input controller 320, and disk controller 322. Network subsystem 318 can include, for example, an Ethernet of WiFi adapter. Input controller 320 can be any known input device technology, including but not limited to a keyboard (including a virtual keyboard), mouse, track ball, and touch-sensitive pad or display. Disk controller 322 can include one or more mass storage devices for storing data files; such devices include magnetic disks, such as internal hard disks and removable disks; magneto-optical disks; and optical disks.

FIG. 4 is an example computing device that can be used within the system 100 of FIG. 1, according to an embodiment of the present disclosure. In some embodiments, device 400 can be a user device 102. The illustrative user device 400 can include a memory interface 402, one or more data processors, image processors, central processing units 404, and or secure processing units 405, and peripherals subsystem 406. Memory interface 402, one or more central processing units 404 and or secure processing units 405, and or peripherals subsystem 406 can be separate components or can be integrated in one or more integrated circuits. The various components in user device 400 can be coupled by one or more communication buses or signal lines.

Sensors, devices, and subsystems can be coupled to peripherals subsystem 406 to facilitate multiple functionalities. For example, motion sensor 410, light sensor 412, and proximity sensor 414 can be coupled to peripherals subsystem 406 to facilitate orientation, lighting, and proximity functions. Other sensors 416 can also be connected to peripherals subsystem 406, such as a global navigation satellite system (GNSS) (e.g., GPS receiver), a temperature sensor, a biometric sensor, magnetometer, or other sensing device, to facilitate related functionalities.

Camera subsystem 420 and optical sensor 422, e.g., a charged coupled device (CCD) or a complementary metal-oxide semiconductor (CMOS) optical sensor, can be utilized to facilitate camera functions, such as recording photographs and video clips. Camera subsystem 420 and optical sensor 422 can be used to collect images of a user to be used during authentication of a user, e.g., by performing facial recognition analysis.

Communication functions can be facilitated through one or more wired and or wireless communication subsystems 424, which can include radio frequency receivers and transmitters and or optical (e.g., infrared) receivers and transmitters. For example, the Bluetooth (e.g., Bluetooth low energy (BTLE)) and or WiFi communications described herein can be handled by wireless communication subsystems 424. The specific design and implementation of communication subsystems 424 can depend on the communication network(s) over which the user device 400 is intended to operate. For example, user device 400 can include communication subsystems 424 designed to operate over a GSM network, a GPRS network, an EDGE network, a WiFi or WiMax network, and a Bluetooth™ network. For example, wireless communication subsystems 424 can include hosting protocols such that device 400 can be configured as a base station for other wireless devices and or to provide a WiFi service.

Audio subsystem 426 can be coupled to speaker 428 and microphone 430 to facilitate voice-enabled functions, such as speaker recognition, voice replication, digital recording, and telephony functions. Audio subsystem 426 can be configured to facilitate processing voice commands, voice-printing, and voice authentication, for example.

I/O subsystem 440 can include a touch-surface controller 442 and or other input controller(s) 444. Touch-surface controller 442 can be coupled to a touch-surface 446. Touch-surface 446 and touch-surface controller 442 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with touch-surface 446.

The other input controller(s) 444 can be coupled to other input/control devices 448, such as one or more buttons, rocker switches, thumb-wheel, infrared port, USB port, and or a pointer device such as a stylus. The one or more buttons (not shown) can include an up/down button for volume control of speaker 428 and or microphone 430.

In some implementations, a pressing of the button for a first duration can disengage a lock of touch-surface 446; and a pressing of the button for a second duration that is longer than the first duration can turn power to user device 400 on or off. Pressing the button for a third duration can activate a voice control, or voice command, module that enables the user to speak commands into microphone 430 to cause the device to execute the spoken command. The user can customize a functionality of one or more of the buttons. Touch-surface 446 can, for example, also be used to implement virtual or soft buttons and or a keyboard.

In some implementations, user device 400 can present recorded audio and or video files, such as MP3, AAC, and MPEG files. In some implementations, user device 400 can include the functionality of an MP3 player, such as an iPod™. User device 400 can, therefore, include a 36-pin connector and or 8-pin connector that is compatible with the iPod. Other input/output and control devices can also be used.

Memory interface 402 can be coupled to memory 450. Memory 450 can include high-speed random access memory and or non-volatile memory, such as one or more magnetic disk storage devices, one or more optical storage devices, and or flash memory (e.g., NAND, NOR). Memory 450 can store an operating system 452, such as Darwin, RTXC, LINUX, UNIX, OS X, Windows, or an embedded operating system such as VxWorks.

Operating system 452 can include instructions for handling basic system services and for performing hardware dependent tasks. In some implementations, operating system 452 can be a kernel (e.g., UNIX kernel). In some implementations, operating system 452 can include instructions for performing voice authentication.

Memory 450 can also store communication instructions 454 to facilitate communicating with one or more additional devices, one or more computers and or one or more servers. Memory 450 can include graphical user interface instructions 456 to facilitate graphic user interface processing; sensor processing instructions 458 to facilitate sensor-related processing and functions; phone instructions 460 to facilitate phone-related processes and functions; electronic messaging instructions 462 to facilitate electronic messaging-related process and functions; web browsing instructions 464 to facilitate web browsing-related processes and functions; media processing instructions 466 to facilitate media processing-related functions and processes; GNSS/Navigation instructions 468 to facilitate GNSS and navigation-related processes and instructions; and or camera instructions 470 to facilitate camera-related processes and functions.

Memory 450 can store application (or “app”) instructions and data 472, such as instructions for the apps described above in the context of FIGS. 1-2. Memory 450 can also store other software instructions 474 for various other software applications in place on device 400.

The described features can be implemented in one or more computer programs that can be executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., Objective-C, Java), including compiled or interpreted languages, and it can be deployed in any form, including as a stand-alone program or as a module, component, subroutine, or other unit suitable for use in a computing environment.

Suitable processors for the execution of a program of instructions can include, by way of example, both general and special purpose microprocessors, and the sole processor or one of multiple processors or cores, of any kind of computer. Generally, a processor can receive instructions and data from a read-only memory or a random access memory or both. The essential elements of a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, the features may be implemented on a computer having a display device such as an LED or LCD monitor for displaying information to the user and a keyboard and a pointing device such as a mouse or a trackball by which the user may provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination thereof. The components of the system may be connected by any form or medium of digital data communication such as a communication network. Examples of communication networks include, e.g., a telephone network, a LAN, a WAN, and the computers and networks forming the Internet.

The computer system may include clients and servers. A client and server may generally be remote from each other and may typically interact through a network. The relationship of client and server may arise by virtue of computer programs running on the respective computers and having a client-server relationship to each other.

One or more features or steps of the disclosed embodiments may be implemented using an API. An API may define one or more parameters that are passed between a calling application and other software code (e.g., an operating system, library routine, function) that provides a service, that provides data, or that performs an operation or a computation.

The API may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call. API calls and parameters may be implemented in any programming language. The programming language may define the vocabulary and calling convention that a programmer will employ to access functions supporting the API.

In some implementations, an API call may report to an application the capabilities of a device running the application, such as input capability, output capability, processing capability, power capability, communications capability, etc.

While various embodiments have been described above, it should be understood that they have been presented by way of example and not limitation. It will be apparent to persons skilled in the relevant art(s) that various changes in form and detail may be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

1. A computing system comprising:
a processor; and
a non-transitory computer-readable storage device storing computer-executable instructions, the instructions when executed by the processor cause the processor to perform operations comprising:
receiving a classification prompt;
analyzing the classification prompt with a large language model (LLM);
receiving a plurality of token probability values from the LLM;
generating a classification prediction based on the received plurality of token probability values; and
transmitting the classification prediction to a user device.

2. The computing system of claim 1, wherein receiving the classification prompt comprises receiving the classification prompt from the user device.

3. The computing system of claim 1, wherein receiving the classification prompt comprises:
monitoring an online platform;
obtaining at least one post from the online platform; and
inserting the at least one post from the online platform into the classification prompt.

4. The computing system of claim 1, wherein receiving a plurality of token probability values from the LLM comprises receiving a token probability vector.

5. The computing system of claim 4, wherein receiving the token probability vector comprises receiving the token probability vector comprising a probability value for each of a plurality of sets of tokens.

6. The computing system of claim 5, wherein receiving the probability values for the plurality of sets of tokens comprises receiving a log-probability value for each of the plurality of sets of tokens.

7. The computing system of claim 4, wherein generating the classification prediction based on the received plurality of token probability values comprises:
extracting, from the token probability vector, one or more token probability values for each of a first and second predefined set of token groups; and
generating the classification prediction based on the one or more extracted token probability values.

8. The computing system of claim 7, wherein:
the first predefined set of token groups is associated with a first class of the classification prompt; and
the second predefined set of token groups is associated with a second class of the classification prompt.

9. The computing system of claim 7, wherein generating the classification prediction based on the one or more extracted token probability values comprises:
calculating a mean token probability value for the first and second predefined set of token groups;
identifying a predefined set of token groups with a highest mean token probability value; and
generating the classification prediction based on the identified predefined set of token groups with the highest mean token probability value.

10. The computing system of claim 7, wherein each of the first and second predefined set of token groups is generated via the LLM.

11. A computer-implemented method, performed by at least one processor, comprising:
receiving a classification prompt;
analyzing the classification prompt with a large language model (LLM);
receiving a plurality of token probability values from the LLM;
generating a classification prediction based on the received plurality of token probability values; and
transmitting the classification prediction to a user device.

12. The computer-implemented method of claim 11, wherein receiving the classification prompt comprises receiving the classification prompt from the user device.

13. The computer-implemented method of claim 11, wherein receiving the classification prompt comprises:
monitoring an online platform;
obtaining at least one post from the online platform; and
inserting the at least one post from the online platform into the classification prompt.

14. The computer-implemented method of claim 11, wherein receiving a plurality of token probability values from the LLM comprises receiving a token probability vector.

15. The computer-implemented method of claim 14, wherein receiving the token probability vector comprises receiving the token probability vector comprising a probability value for each of a plurality of sets of tokens.

16. The computer-implemented method of claim 15, wherein receiving the probability values for the plurality of sets of tokens comprises receiving a log-probability value for each of the plurality of sets of tokens.

17. The computer-implemented method of claim 14, wherein generating the classification prediction based on the received plurality of token probability values comprises:
extracting, from the token probability vector, one or more token probability values for each of a first and second predefined set of token groups; and
generating the classification prediction based on the one or more extracted token probability values.

18. The computer-implemented method of claim 17, wherein:
the first predefined set of token groups is associated with a first class of the classification prompt; and
the second predefined set of token groups is associated with a second class of the classification prompt.

19. The computer-implemented method of claim 17, wherein generating the classification prediction based on the one or more extracted token probability values comprises:
calculating a mean token probability value for the first and second predefined set of token groups;
identifying a predefined set of token groups with a highest mean token probability value; and
generating the classification prediction based on the identified predefined set of token groups with the highest mean token probability value.

20. The computer-implemented method of claim 17, wherein each of the first and second predefined set of token groups is generated via the LLM.
